(19) United States
(12) Patent Application Publication
(10) Pub. No.: US 2025/0313999 A1
(43) Pub. Date: Oct. 9, 2025

(54) WIRELESS AND BATTERY-FREE TOUCH-RESPONSIVE LUMINESCENT FIBER, PREPARATION METHOD, AND USE THEREOF

(71) Applicant: FIRST FIBER (SUZHOU) TECHNOLOGY CO., LTD., Suzhou City (CN)

(72) Inventors: Yang GUO, Suzhou City (CN); Weifeng YANG, Suzhou City (CN); Wei GONG, Suzhou City (CN); Bo WU, Suzhou City (CN); Zhifu LIU, Suzhou City (CN)

(73) Assignee: FIRST FIBER (SUZHOU) TECHNOLOGY CO., LTD., Suzhou City (CN)

(21) Appl. No.: 18/758,990

(22) Filed: Jun. 28, 2024

(30) Foreign Application Priority Data
Apr. 7, 2024 (CN) 202410410919.1

(51) Int. Cl. D03D 15/547; C08K 3/30; C08K 9/02; C09K 11/02; C09K 11/58; D03D 15/217; D03D 15/292; D03D 15/533; D03D 15/67; D06M 11/46; D06M 11/51; D06M 11/74; D06M 15/643; D06M 101/16; F21K 2/04

(52) U.S. Cl. CPC D03D 15/547; C08K 3/30; C08K 9/02; C09K 11/02; C09K 11/584; C09K 11/586; D03D 15/217; D03D 15/292; D03D 15/533; D03D 15/67; D06M 11/46; D06M 11/51; D06M 11/74; D06M 15/643; F21K 2/04; C08K 2003/3036; D06M 2101/16; D06M 2200/00; D10B 2501/00

(57) ABSTRACT

Provided are a wireless and battery-free touch-responsive luminescent fiber and a preparation method and use thereof. The wireless and battery-free touch-responsive luminescent fiber includes a conductive core layer, a dielectric layer and a light-emitting layer sequentially from inside to outside, wherein the conductive core layer is a conductive fiber material; the dielectric layer is a first composite resin containing a high dielectric constant filler, the high dielectric constant filler having a dielectric constant of 10-80; and the light-emitting layer is a second composite resin containing a rare earth luminescent material. The preparation method includes steps of subjecting the conductive core layer to fiber pay-off, dielectric layer slurry impregnation, first heating, light-emitting layer slurry impregnation and second heating in sequence to obtain the wireless and battery-free touch-responsive luminescent fiber.

### CROSS-REFERENCE TO RELATED APPLICATIONS

This application claims foreign priority benefits under 35 U.S.C. § 119 (a)-(d) to Chinese Patent Application No. 202410410919.1 filed on Apr. 7, 2024, the disclosure of which is hereby incorporated herein by reference in its entirety.

### TECHNICAL FIELD

The present disclosure belongs to the technical field of functional material preparation, and particularly relates to a wireless and battery-free touch-responsive luminescent fiber and a preparation method and use thereof.

### BACKGROUND

Luminescent/display textile has important application value in fields such as smart wearables and smart clothing, and is a hotspot of the current research (Matter, 2020, 2 (4): 882-895).

At present, luminescent fiber activated based on electric field is usually driven by a high-voltage alternating-current (AC) electric field. Hence, a high-voltage module and a battery are connected to one end of the luminescent fiber to invert and boost an output voltage signal (Nature, 2021, 591 (7849): 240-245). This makes it necessary to include an additional cumbersome and complicated energy management module when applying the luminescent fiber in the fields of smart wearables and smart clothing, which results in that the comfort and convenience of the luminescent fiber as a textile are reduced considerably.

### SUMMARY

The present disclosure aims to provide a wireless and battery-free touch-responsive luminescent fiber and a preparation method and use thereof. The touch-responsive luminescent fiber according to the present disclosure realizes wireless and battery-free driving.

To achieve the above objects, the present disclosure provides the following technical solutions:

The present disclosure provides a wireless and battery-free touch-responsive luminescent fiber, including a conductive core layer, a dielectric layer and a light-emitting layer sequentially from inside to outside,
where the conductive core layer is a conductive fiber material;
the dielectric layer is a first composite resin containing a high dielectric constant filler, the high dielectric constant filler having a dielectric constant of 10-80; and
the light-emitting layer is a second composite resin containing a rare earth luminescent material.

In some embodiments, the rare earth luminescent material is a ZnS-containing rare earth luminescent material;
a resin matrix in the light-emitting layer includes at least one selected from the group consisting of an epoxy resin, polydimethylsiloxane, a hydrogenated styrene-butadiene block copolymer and polyurethane; and
a mass ratio of the rare earth luminescent material to the resin matrix in the light-emitting layer is in a range of 100:100-200.

In some embodiments, the ZnS-containing rare earth luminescent material includes at least one selected from the group consisting of ZnS:Mn, ZnS:Cn, ZnS:Eu and ZnS/CaZnOS:Mn.

In some embodiments, the conductive fiber material includes at least one selected from the group consisting of a metal fiber material, a polymer fiber material and a carbon fiber material.

In some embodiments, the high dielectric constant filler includes at least one selected from the group consisting of titanate, a carbon material and an ionic liquid;
a resin matrix in the dielectric layer includes at least one selected from the group consisting of an epoxy resin, polydimethylsiloxane, a hydrogenated styrene-butadiene block copolymer and polyurethane; and
a mass ratio of the high dielectric constant filler to the resin matrix in the dielectric layer is in a range of 100:80-150.

The present disclosure further provides a method for preparing the wireless and battery- free touch-responsive luminescent fiber, including steps of:
subjecting the conductive core layer to fiber pay-off, dielectric layer slurry impregnation, first heating, light-emitting layer slurry impregnation and second heating in sequence to obtain the wireless and battery-free touch-responsive luminescent fiber.

In some embodiments, the first heating is conducted at a temperature of 150-180° C. for 10-60 s.

In some embodiments, the second heating is conducted at a temperature of 140-200° C. for 10-60 s.

The present disclosure further provides a luminescent fiber textile, including a cotton fiber, a conductive fiber and a wireless and battery-free touch-responsive luminescent fiber that are woven with each other, where the wireless and battery-free touch-responsive luminescent fiber is the wireless and battery-free touch-responsive luminescent fiber as described in the above solutions or a wireless and battery-free touch-responsive luminescent fiber prepared by the method as described in the above solutions.

The present disclosure further provides use of the wireless and battery-free touch-responsive luminescent fiber as described in the above solution or a wireless and battery-free touch-responsive luminescent fiber prepared by the method as described in the above solution in a flexible electronic field, a smart clothing field and an intelligent display field.

The present disclosure provides a wireless and battery-free touch-responsive luminescent fiber. Regarding the touch-responsive luminescent fiber according to the present disclosure, when a light-emitting layer therein contacts a low-impedance substance, an interfacial contact capacitor could be formed to capture environmental electromagnetic energy, thereby activating a luminescent material on a contact interface to radiate visible light. Energy sources for wireless driving include a frictional electrostatic field (1-5 Hz) generated by a motion of a human body, a low-frequency wireless electric field (50 Hz) of a transmission line, a wireless electromagnetic field in wireless power transmission (100 kHz), a wireless electromagnetic field (13.56 MHz) in near field communication (NFC) and the like. FIG. 1 schematically illustrates a flow direction of wireless energy, and the environmental electromagnetic energy flows to the ground after passing through the fiber and the human body. By introducing the high dielectric constant material, the capacitance of the touch-responsive luminescent fiber could be improved, thereby improving a capture efficiency for the environmental electromagnetic energy. Without depending on such electronic elements as a power supply and a processor, the touch-responsive luminescent fiber according to the present disclosure can realize underwater light emission, touch-responsive light emission, humidity sensing and the like, and get rid of dependence on an existing Von Neumann architecture like the chip and the power supply.

The present disclosure further provides a method for preparing the wireless and battery-free touch-responsive luminescent fiber as described in the above solutions. In the present disclosure, the touch-responsive luminescent fiber is prepared by an improved melt coating method based on a multilayer packaging technique, allowing batch preparation and continuous weaving.

The present disclosure further provides a luminescent fiber textile, including a cotton fiber, a conductive fiber and a wireless and battery-free touch-responsive luminescent fiber that are woven with each other. The luminescent fiber textile according to the present disclosure is worn comfortably, has a light weight and a relatively high energy utilization efficiency and is environmentally friendly.

The present disclosure further provides use of the wireless and battery-free touch-responsive luminescent fiber as described in the above solutions or the wireless and battery-free touch-responsive luminescent fiber prepared by the method as described in the above solutions in a flexible electronic field, a smart clothing field and an intelligent display field. The touch-responsive luminescent fiber according to the present disclosure overcomes problems of the existing electroluminescent fiber component in seamless integration, energy efficiency and service performance due to dependence on a power supply and a chip module, provides new solutions for seamless integration, comfort and the like of the future smart clothing, has a broad application prospect in the flexible electronic field, the smart clothing field and the intelligent display field, and is particularly applied to humidity sensing, underwater light emission and tactile sensing and the like.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 schematically illustrates energy transmission when the wireless and battery-free touch-responsive luminescent fiber according to the present disclosure emits light;

FIG. 2 schematically illustrates continuous preparation of the wireless and battery-free touch-responsive luminescent fiber according to the present disclosure;

FIG. 3A to FIG. 3C illustrate scanning electron microscope (SEM) images of the wireless and battery-free touch-responsive luminescent fiber according to the present disclosure, where FIG. 3A illustrates a three-layer distribution of the fiber, FIG. 3B illustrates a distribution of a dielectric layer in a resin matrix, and FIG. 3C illustrates a distribution of a rare earth luminescent material in a resin matrix;

FIG. 4A to FIG. 4D schematically illustrate use examples of the wireless and battery-free touch-responsive luminescent fiber according to the present disclosure, where FIG. 4A and FIG. 4B illustrate wireless visualized humidity sensing, FIG. 4C illustrates wireless tactile sensing, and FIG. 4D illustrates underwater light emission; and

FIG. 5A to FIG. 5C schematically illustrate structure and mechanism of the luminescent fiber fabric according to the present disclosure, where FIG. 5A schematically illustrates capture of environmental electromagnetic energy, FIG. 5B schematically illustrates weaving of the wireless and battery-free touch-responsive luminescent fiber, and FIG. 5C illustrates a sectional structure of the wireless and battery-free touch-responsive luminescent fiber, in which 1: conductive core layer, 2: dielectric layer, 3: light-emitting layer, and 4: light-emitting interface.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The present disclosure provides a wireless and battery-free touch-responsive luminescent fiber, including a conductive core layer, a dielectric layer and a light-emitting layer sequentially from inside to outside. The conductive core layer is a conductive fiber material. The dielectric layer is a first composite resin containing a high dielectric constant filler. The high dielectric constant filler has a dielectric constant of 10-80. The light-emitting layer is a second composite resin containing a rare earth luminescent material.

The wireless and battery-free touch-responsive luminescent fiber according to the present disclosure includes the conductive core layer. In some embodiments of the present disclosure, the conductive fiber material includes one or more selected from the group consisting of a metal fiber material, a polymer fiber material and a carbon fiber material. In some embodiments, the metal fiber material includes one or more selected from the group consisting of a copper wire, a nickel wire, a stainless steel yarn and a memory alloy fiber. In some embodiments, the polymer fiber material includes one or two selected from the group consisting of a silver-plated nylon yarn and a poly(3,4-ethylenedioxythiophene):poly(4-styrenesulfonate) (PEDOT:PSS) fiber. In some embodiments, the carbon fiber material is a conductive carbon fiber.

The wireless and battery-free touch-responsive luminescent fiber according to the present disclosure includes the dielectric layer. In some embodiments of the present disclosure, the high dielectric constant filler in the dielectric layer includes one or more selected from the group consisting of titanate, a carbon material and an ionic liquid. In some embodiments, the titanate includes one or more selected from the group consisting of barium titanate and barium strontium titanate. In some embodiments, the ionic liquid includes one or more selected from the group consisting of 1-methylimidazole trifluoromethanesulfonate, 1-methylimidazole trifluoroacetate and 1-buthylimidazole chloride. In some embodiments, the carbon material includes one or more selected from the group consisting of a graphene nanosheet and a carbon nanotube.

In some embodiments of the present disclosure, a resin matrix in the dielectric layer includes one or more selected from the group consisting of an epoxy resin, polydimethylsiloxane, a hydrogenated styrene-butadiene block copolymer and polyurethane.

In some embodiments of the present disclosure, a mass ratio of the high dielectric constant filler to the resin matrix is in a range of 100:80-150, preferably 100:100-140, and more preferably 100:110-130.

In some embodiments of the present disclosure, a ratio of a thickness of the dielectric layer to a diameter of the conductive core layer is in a range of 100:80-150, preferably 100:100-130, and more preferably 100:100-120.

The wireless and battery-free touch-responsive luminescent fiber according to the present disclosure includes the light-emitting layer. In some embodiments of the present disclosure, the rare earth luminescent material is a ZnS-containing rare earth luminescent material. In some embodiments, the ZnS-containing rare earth luminescent material includes one or more selected from the group consisting of ZnS:Mn (Mn doped Zns), ZnS:Cn (Cn doped Zns), ZnS:Eu (Eu doped Zns) and ZnS/CaZnOS:Mn (Mn doped ZnS/CaZnOS).

In some embodiments of the present disclosure, a resin matrix in the light-emitting layer includes one or more selected from the group consisting of an epoxy resin, polydimethylsiloxane, a hydrogenated styrene-butadiene block copolymer and polyurethane.

In some embodiments of the present disclosure, a mass ratio of the rare earth luminescent material to the resin matrix in the light-emitting layer is in a range of 100:100-200, preferably 100:120-180, and more preferably 100:140-160.

In some embodiments of the present disclosure, a ratio of a diameter of the conductive core layer to a diameter of the touch-responsive luminescent fiber is in a range of 100:(200-300), preferably 100:200-250, and more preferably 100:200-225.

In some embodiments of the present disclosure, the diameter of the touch-responsive luminescent fiber is in a range of 100-400 μm, and preferably 200-300 μm.

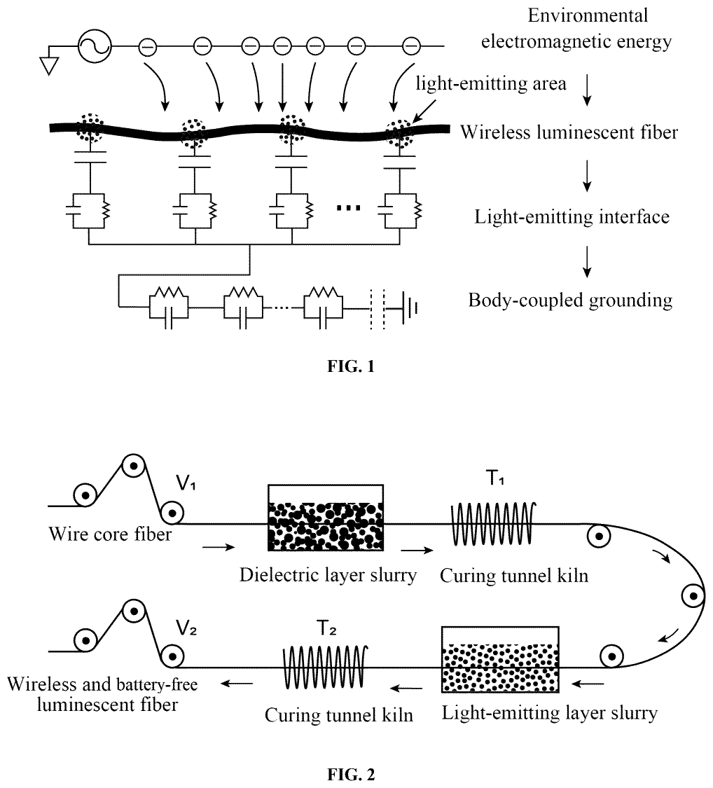

Regarding the touch-responsive luminescent fiber according to the present disclosure, when a light-emitting layer therein contacts a low-impedance substance, an interfacial contact capacitor could be formed to capture environmental electromagnetic energy, thereby activating a luminescent material on a contact interface to radiate visible light. Energy sources for wireless driving include a frictional electrostatic field (1-5 Hz) generated by a motion of a human body, a low-frequency wireless electric field (50 Hz) of a transmission line, a wireless electromagnetic field in wireless power transmission (100 kHz), a wireless electromagnetic field (13.56 MHz) in near field communication (NFC) and the like. FIG. 1 schematically illustrates a flow direction of wireless energy. The environmental electromagnetic energy flows to the ground after passing through the fiber and the human body.

In the present disclosure, by introducing the high dielectric constant material, the capacitance of the touch-responsive luminescent fiber could be improved, thereby enabling the touch-responsive luminescent fiber to improve a capture efficiency for the environmental electromagnetic energy.

The touch-responsive luminescent fiber according to the present disclosure is powered itself by acquiring an electromagnetic field in the environment. Without depending on such electronic elements as a power supply and a processor, the touch-responsive luminescent fiber could realize underwater light emission, touch-responsive light emission, humidity sensing and the like, and get rid of dependence on an existing Von Neumann architecture like the chip and the power supply.

The present disclosure further provides a method for preparing the wireless and battery-free touch-responsive luminescent fiber, including the following steps:
subjecting the conductive core layer to fiber pay-off, dielectric layer slurry impregnation, first heating, light-emitting layer slurry impregnation and second heating in sequence to obtain the wireless and battery-free touch-responsive luminescent fiber.

In some embodiments of the present disclosure, a pay-off velocity (V₁) in the fiber pay- off is in a range of 15-25 rad/min, preferably 18-22 rad/min, and more preferably 20 rad/min.

In some embodiments of the present disclosure, the first heating is conducted at a temperature (T₁) of 150-180° C., preferably 160-170° C., and more preferably 165° C.; and the first heating is conducted for 10-60 s, preferably 15-40 s, and more preferably 18-25 s. In some embodiments, the first heating is conducted in a device, and the device is a heating tunnel kiln.

In some embodiments of the present disclosure, the second heating is conducted at a temperature (T₂) of 140-200° C., preferably 150-180° C., and more preferably 160-170° C.; and the second heating is conducted for 10-60 s, preferably 15-30 s, and more preferably 18-22 s. In some embodiments, the second heating is conducted in a device, and the device is a heating tunnel kiln.

In some embodiments of the present disclosure, the method further includes fiber collection after the second heating. In some embodiments, a collecting velocity (V₂) in the fiber collection is in a range of 10-30 rad/min, preferably 15-25 rad/min, and more preferably 20rad/min. In some embodiments, by adjusting the pay-off velocity and the collecting velocity, and managing a duration for the dielectric layer slurry impregnation, the first heating, the light-emitting layer slurry impregnation and the second heating, a coating thickness of the touch-responsive luminescent fiber may be controlled.

The present disclosure further provides a luminescent fiber textile, including a cotton fiber, a conductive fiber and a wireless and battery-free touch-responsive luminescent fiber that are woven with each other. The wireless and battery-free touch-responsive luminescent fiber is the wireless and battery-free touch-responsive luminescent fiber in the above solutions or the wireless and battery-free touch-responsive luminescent fiber prepared by the method in the above solutions.

In some embodiments of the present disclosure, a mass ratio of the cotton fiber to the touch-responsive luminescent fiber is in a range of 100-150:1, and preferably 100-120:1.

In some embodiments of the present disclosure, the conductive fiber is a metal wire. In further embodiments, the metal wire includes one or more selected from the group consisting of a copper wire, an aluminum wire and an iron wire.

In some embodiments of the present disclosure, a mass ratio of the conductive fiber to the touch-responsive luminescent fiber is in a range of 1:0.75-0.80, and preferably 1:0.8.

In some embodiments of the present disclosure, a spacing between the touch-responsive luminescent fiber and the conductive fiber is in a range of 0.5-3 mm, and preferably 1 mm.

The luminescent fiber textile according to the present disclosure has an average mass density of 1-1.2 g/cm³, which is far less than that of a luminescent fiber driven by a high-voltage AC electric field.

The present disclosure further provides use of the wireless and battery-free touch-responsive luminescent fiber in the above solutions or the wireless and battery-free touch-responsive luminescent fiber prepared by the method in the above solutions in a flexible electronic field, a smart clothing field and an intelligent display field.

The touch-responsive luminescent fiber according to the present disclosure overcomes problems of the existing electroluminescent fiber component in seamless integration, energy efficiency and service performance due to dependence on a power supply and a chip module, provides new solutions for seamless integration, comfort and the like of the future smart clothing, has a broad application prospect in the flexible electronic field, the smart clothing field and the intelligent display field, and is particularly applied to such fields as humidity sensing, underwater light emission and tactile sensing.

In order to further illustrate the present disclosure, the technical solutions of the present disclosure are described in detail below in connection with accompanying drawings and examples, but these examples should not be understood as a limit to the scope of the present disclosure.

In specific examples of the present disclosure, sources or parameters of raw materials and reagents are as follows:
Polydimethylsiloxane (Dow Corning, USA), ZnS: Cu (Shanghai Keyan Photoelectric Technology Co., Ltd., China), ZnS/CaZnOS:Mn (Shanghai Keyan Photoelectric Technology Co., Ltd., China), carbon nanotube (Shanghai Keyan Photoelectric Technology Co., Ltd., China), barium titanate powder (chemically pure, Sinopharm Chemical Reagent Co., Ltd., China), barium strontium titanate powder (chemically pure, Sinopharm Chemical Reagent Co., Ltd., China), copper wire (with a diameter of 0.2 mm), silver-plated nylon wire (with a diameter of 0.2 mm, Shanghai Keyan Photoelectric Technology Co., Ltd., China), and cotton fiber (Zhejiang Hengyi Group Co., Ltd., China).

### Example 1

Barium titanate powder was dispersed in polydimethylsiloxane (at a mass ratio of 1:1). A resultant was stirred mechanically for 30 min, defoamed for 15 min in a vacuum oven, and then pre-cured for 15 min at 80° C. to obtain a dielectric layer slurry.

ZnS:Cu luminescent powder was dispersed in polydimethylsiloxane (at a mass ratio of 1:1). A resultant was stirred mechanically for 30 min, defoamed for 15 min in the vacuum oven, and then pre-cured for 15 min at 80° C. to obtain a light-emitting layer slurry.

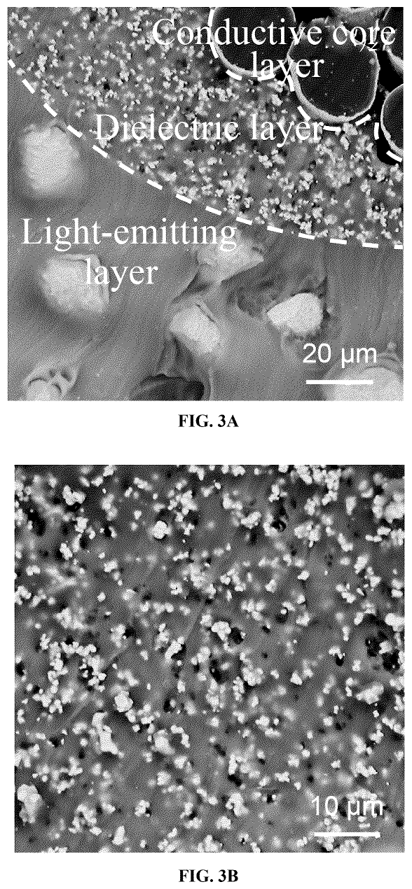

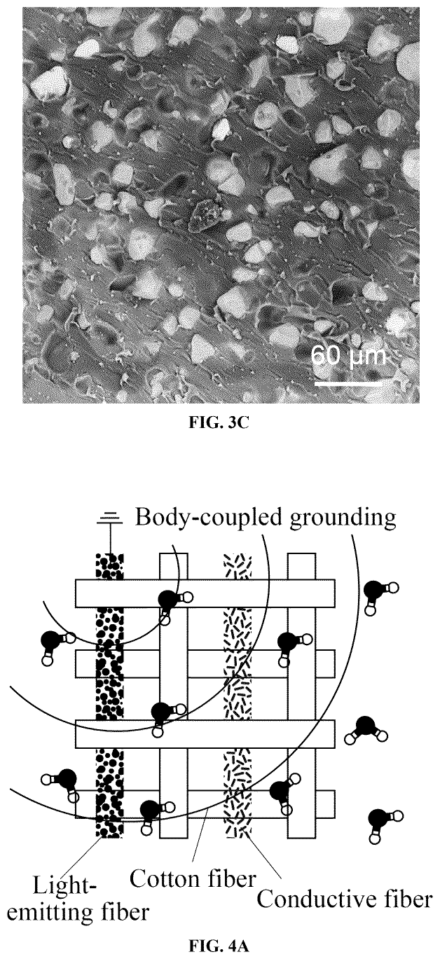

With an improved melt coating technique (with a flowchart as shown in FIG. 2), a copper wire with a diameter of 0.2 mm passed through the dielectric layer slurry, a heating tunnel kiln 1 (150° C.), the light-emitting layer slurry and a heating tunnel kiln 2 (170° C.) at a pay-off velocity of 15 rad/min. A resulting fiber was collected at a collecting velocity of 16 rad/min to obtain a wireless and battery-free touch-responsive luminescent fiber. The touch-responsive luminescent fiber was analyzed by an SEM to obtain an SEM image as shown in FIG. 3A to FIG. 3C. As can be seen from FIG. 3A, there is desirable interface bonding between a conductive core layer, a dielectric layer and a light-emitting layer. As can be seen from FIG. 3B, a high dielectric constant filler is uniformly dispersed in a resin matrix. As can be seen from FIG. 3C, a rare earth luminescent material is uniformly dispersed in a resin matrix.

### Example 2

Carbon nanotube powder was dispersed in polydimethylsiloxane (at a mass ratio of 10:8). A resultant was stirred mechanically for 30 min, defoamed for 15 min in a vacuum oven, and then pre-cured for 15 min at 80° C. to obtain a dielectric layer slurry.

ZnS/CaZnOS:Mn luminescent powder was dispersed in polydimethylsiloxane (at a mass ratio of 15:10). A resultant was stirred mechanically for 30 min, defoamed for 15 min in the vacuum oven, and then pre-cured for 15 min at 80° C. to obtain a light-emitting layer slurry.

With an improved melt coating technique (with a flowchart as shown in FIG. 2), a silver-plated nylon wire with a diameter of 0.2 mm passed through the dielectric layer slurry, a heating tunnel kiln 1 (180° C.), the light-emitting layer slurry and a heating tunnel kiln 2 (190° C.) at a pay-off velocity of 20 rad/min. A resulting fiber was collected at a collecting velocity of 20 rad/min to obtain a wireless and battery-free touch-responsive luminescent fiber.

### Example 3

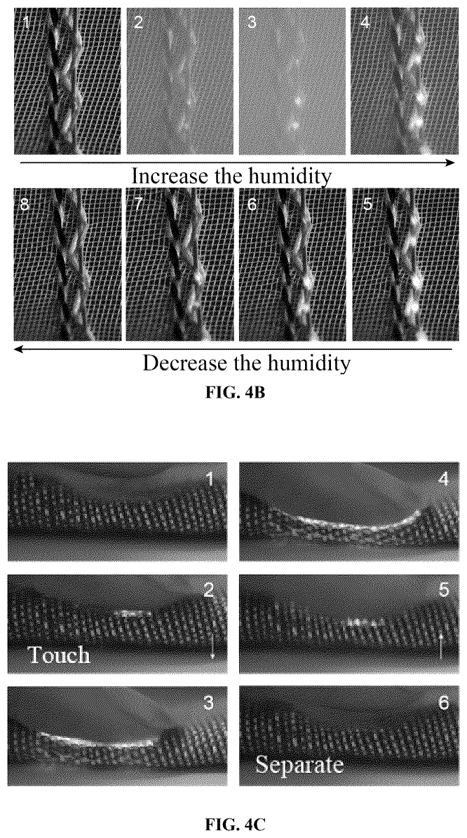

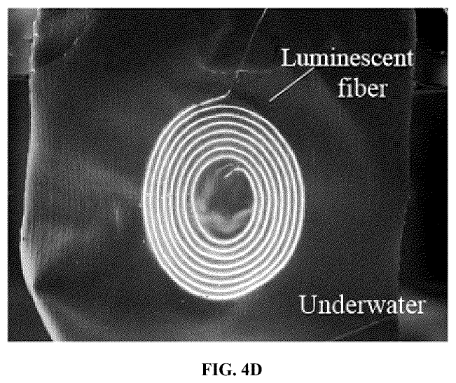

The touch-responsive luminescent fiber prepared in Example 1 was woven with a cotton fiber and a copper wire according to the manner shown in FIG. 4A to obtain a luminescent fiber textile. A spacing between the touch-responsive luminescent fiber and the copper wire is 1 mm.

Under an environmental electromagnetic condition (30 dBm, 20 kHz), different humidities were introduced. The luminescent fiber fabric has a humidity response as shown in FIG. 4B. As can be seen from FIG. 4B, while the humidity increases, the electromagnetic energy captured by the interface of the touch-responsive luminescent fiber increases to achieve a higher luminance. While the humidity decreases, the electromagnetic energy captured by the interface of the touch-responsive luminescent fiber decreases to achieve a lower luminance.

By placing the woven luminescent fiber textiles in the same electromagnetic environment, and touching the luminescent fiber with a finger, the fiber shows a touch-responsive light-emitting phenomenon as shown in FIG. 4C. As can be seen from FIG. 4C, while the finger touches the interface of the touch-responsive luminescent fiber, the environmental electromagnetic energy can be effectively captured, thereby driving the material of the interface of the touch-responsive luminescent fiber to emit light, and realizing wireless and battery-free visualized tactile sensing applications.

Under an environmental electromagnetic condition (30 dBm, 20 kHz), the patterned touch-responsive luminescent fiber embroidered on a fabric base was placed into deionized water, with one end exposing a conductive core layer. By touching the conductive core layer with a finger, results are shown in FIG. 4A to FIG. 4D. As can be seen from FIG. 4C, the touch-responsive luminescent fiber can effectively couple the environmental electromagnetic energy to the surface of the touch-responsive luminescent fiber, thereby activating the touch-responsive luminescent fiber and realizing underwater light emission applications.

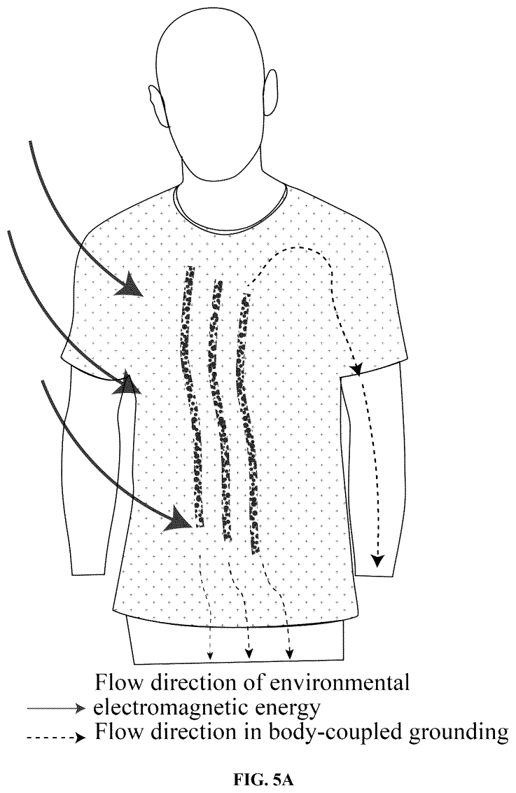

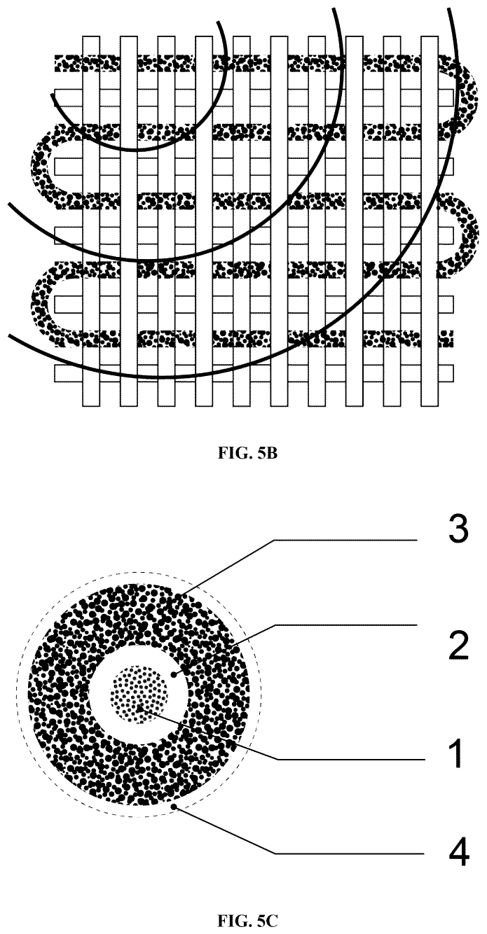

The luminescent fiber textile prepared in this example was on volunteers, and the structure and mechanism of the luminescent fiber textile are shown in FIG. 5A to FIG. 5C. As can be seen from FIG. 5A to FIG. 5C, the luminescent fiber textile can guide the environmental electromagnetic energy to pass through the fiber and the human body sequentially and then flow to the ground (as shown in FIG. 5A), thereby activating different regions of the touch-responsive luminescent fiber to emit light (as shown in FIG. 5B).

### Example 4

Barium strontium titanate powder was dispersed in polydimethylsiloxane (at a mass ratio of 10:12). A resultant was stirred mechanically for 30 min, defoamed for 15 min in a vacuum oven, and then pre-cured for 15 min at 80° C. to obtain a dielectric layer slurry.

ZnS:Cu luminescent powder was dispersed in polydimethylsiloxane (at a mass ratio of 10:15). A resultant was stirred mechanically for 30 min, defoamed for 15 min in the vacuum oven, and then pre-cured for 15 min at 80° C. to obtain a light-emitting layer slurry.

With an improved melt coating technique (with a flowchart as shown in FIG. 2), a silver-plated nylon wire with a diameter of 0.2 mm passed through the dielectric layer slurry, a heating tunnel kiln 1 (180° C.), the light-emitting layer slurry and a heating tunnel kiln 2 (200° C.) at a pay-off velocity of 25 rad/min. A resulting fiber was collected at a collecting velocity of 25 rad/min to obtain a wireless and battery-free touch-responsive luminescent fiber.

As can be seen from the above examples, without depending on such electronic elements as a power supply and a processor, the touch-responsive luminescent fiber according to the present disclosure can realize underwater light emission, touch-responsive light emission, humidity sensing and the like.

Although the present disclosure is described in detail in conjunction with the foregoing embodiments, they are only a part of, not all of, the embodiments of the present disclosure. Other embodiments can be obtained based on these embodiments without creative efforts, and all of these embodiments shall fall within the scope of the present disclosure.

What is claimed is:

1. A wireless and battery-free touch-responsive luminescent fiber, comprising a conductive core layer, a dielectric layer and a light-emitting layer sequentially from inside to outside, wherein
the conductive core layer is a conductive fiber material;
the dielectric layer is a first composite resin containing a high dielectric constant filler, the high dielectric constant filler having a dielectric constant of 10-80; and
the light-emitting layer is a second composite resin containing a rare earth luminescent material.

2. The wireless and battery-free touch-responsive luminescent fiber according to claim 1, wherein the rare earth luminescent material is a ZnS-containing rare earth luminescent material;
a resin matrix in the light-emitting layer comprises at least one selected from the group consisting of an epoxy resin, polydimethylsiloxane, a hydrogenated styrene-butadiene block copolymer and polyurethane; and
a mass ratio of the rare earth luminescent material to the resin matrix in the light-emitting layer is in a range of 100:100-200.

3. The wireless and battery-free touch-responsive luminescent fiber according to claim 1, wherein the ZnS-containing rare earth luminescent material comprises at least one selected from the group consisting of ZnS:Mn, ZnS:Cn, ZnS:Eu and ZnS/CaZnOS:Mn.

4. The wireless and battery-free touch-responsive luminescent fiber according to claim 1, wherein the conductive fiber material comprises at least one selected from the group consisting of a metal fiber material, a polymer fiber material and a carbon fiber material.

5. The wireless and battery-free touch-responsive luminescent fiber according to claim 1, wherein the high dielectric constant filler comprises at least one selected from the group consisting of titanate, a carbon material and an ionic liquid;
a resin matrix in the dielectric layer comprises at least one selected from the group consisting of an epoxy resin, polydimethylsiloxane, a hydrogenated styrene-butadiene block copolymer and polyurethane; and
a mass ratio of the high dielectric constant filler to the resin matrix in the dielectric layer is in a range of 100:80-150.

6. A method for preparing the wireless and battery-free touch-responsive luminescent fiber according to claim 1, comprising steps of:
subjecting the conductive core layer to fiber pay-off, dielectric layer slurry impregnation, first heating, light-emitting layer slurry impregnation and second heating in sequence to obtain the wireless and battery-free touch-responsive luminescent fiber.

7. The method according to claim 6, wherein the first heating is conducted at a temperature of 150-180° C. for 10-60 s.

8. The method according to claim 6, wherein the second heating is conducted at a temperature of 140-200° C. for 10-60 s.

9. A luminescent fiber textile, comprising a cotton fiber, a conductive fiber and a wireless and battery-free touch-responsive luminescent fiber that are woven with each other, wherein the wireless and battery-free touch-responsive luminescent fiber is the wireless and battery-free touch-responsive luminescent fiber according to claim 1.

10. The wireless and battery-free touch-responsive luminescent fiber according to claim 2, wherein the ZnS-containing rare earth luminescent material comprises at least one selected from the group consisting of ZnS:Mn, ZnS:Cn, ZnS:Eu and ZnS/CaZnOS:Mn.

11. The method according to claim 6, wherein the rare earth luminescent material is a ZnS-containing rare earth luminescent material;
a resin matrix in the light-emitting layer comprises at least one selected from the group consisting of an epoxy resin, polydimethylsiloxane, a hydrogenated styrene-butadiene block copolymer and polyurethane; and
a mass ratio of the rare earth luminescent material to the resin matrix in the light-emitting layer is in a range of 100:100-200.

12. The method according to claim 6, wherein the ZnS-containing rare earth luminescent material comprises at least one selected from the group consisting of ZnS:Mn, ZnS:Cn, ZnS:Eu and ZnS/CaZnOS:Mn.

13. The method according to claim 6, wherein the conductive fiber material comprises at least one selected from the group consisting of a metal fiber material, a polymer fiber material and a carbon fiber material.

14. The method according to claim 6, wherein the high dielectric constant filler comprises at least one selected from the group consisting of titanate, a carbon material and an ionic liquid;
a resin matrix in the dielectric layer comprises at least one selected from the group consisting of an epoxy resin, polydimethylsiloxane, a hydrogenated styrene-butadiene block copolymer and polyurethane; and
a mass ratio of the high dielectric constant filler to the resin matrix in the dielectric layer is in a range of 100:80-150.

15. The luminescent fiber textile according to claim 9, wherein the rare earth luminescent material is a ZnS-containing rare earth luminescent material;
a resin matrix in the light-emitting layer comprises at least one selected from the group consisting of an epoxy resin, polydimethylsiloxane, a hydrogenated styrene-butadiene block copolymer and polyurethane; and
a mass ratio of the rare earth luminescent material to the resin matrix in the light-emitting layer is in a range of 100:100-200.

16. The luminescent fiber textile according to claim 9, wherein the ZnS-containing rare earth luminescent material comprises at least one selected from the group consisting of ZnS:Mn, ZnS:Cn, ZnS:Eu and ZnS/CaZnOS:Mn.

17. The luminescent fiber textile according to claim 9, wherein the conductive fiber material comprises at least one selected from the group consisting of a metal fiber material, a polymer fiber material and a carbon fiber material.

18. The luminescent fiber textile according to claim 9, wherein the high dielectric constant filler comprises at least one selected from the group consisting of titanate, a carbon material and an ionic liquid;
a resin matrix in the dielectric layer comprises at least one selected from the group consisting of an epoxy resin, polydimethylsiloxane, a hydrogenated styrene-butadiene block copolymer and polyurethane; and
a mass ratio of the high dielectric constant filler to the resin matrix in the dielectric layer is in a range of 100:80-150.
